(19) United States
(12) Patent Application Publication
(10) Pub. No.: US 2010/0069152 A1
(43) Pub. Date: Mar. 18, 2010

(54) METHOD OF GENERATING IMAGE USING VIRTUAL CAMERA, STORAGE MEDIUM, AND COMPUTER DEVICE

(75) Inventors: Norihiro NISHIMURA, Tokyo (JP); Akihiro YOSHIDA, Tokyo (JP); Taro SASAHARA, Tokyo (JP); Manabu ONODERA, Fujisawa-shi (JP)

Correspondence Address: OLIFF & BERRIDGE, PLC, P.O. BOX 320850, ALEXANDRIA, VA, 22320-4850, US

(73) Assignee: NAMCO BANDAI GAMES INC., TOKYO (JP)

(21) Appl. No.: 12/558,134

(22) Filed: Sep. 11, 2009

(30) Foreign Application Priority Data
Sep. 16, 2008 (JP) 2008-237227

(51) Int. Cl. G06F 17/00

(52) U.S. Cl. 463/31

(57) ABSTRACT

An object group is selected from enemy groups a and b that are positioned within the current battle area. A reference point that corresponds to the representative point of the positions of all enemy NPCs that belong to the selected group is calculated A target angle of view at which all of the enemy NPCs included in the object group can be photographed when a photographing direction of a virtual camera aims at the reference point is calculated. The virtual camera is controlled so that the photographing direction aims at the reference point and the angle of view coincides with the target angle of view.

Japanese Patent Application No. 2008-237227 filed on Sep. 16, 2008, is hereby incorporated by reference in its entirety.

### BACKGROUND

A consumer game device and an arcade game device have been known as computer devices. These game devices are also generically referred to as video game devices. Characters that appears in a video game include a player's character that can be operated by the player and a non-playable character (NPC) of which the operation is automatically controlled. In particular, the operation of an enemy NPC that mainly attacks the player's character is controlled so that the enemy NPC searches for, approaches, and attacks the player's character. The player enjoys the game while attacking the NPC that approaches the player's character by operating the player's character.

A method of displaying the NPC on the game screen (i.e., a method of controlling a virtual camera in order to photograph the NPC) is an important factor that affects the game screen and the game operability. In particular, when implementing a gun shooting game in which the player adjusts the sight position using a gun-type controller or the like and shoots the NPC (target), it is desirable to implement realistic camera work while appropriately displaying the NPC on the game screen so that the player can easily determine the target.

As technology that satisfies such a demand, technology that moves the virtual camera along a virtual sphere formed around the NPC (object) while controlling the virtual camera to follow the NPC so that the NPC is displayed at the center of the screen has been known, for example. Since the radius of the virtual sphere is increased corresponding to the number of NPCs (objects), the main object NPC can be displayed at the center of the screen while appropriately displaying other NPCs on the screen in a situation in which a plurality of NPCs approach the player's character (see Japanese Patent No. 3871224, for example).

In recent years, the NPC is controlled to autonomously operate along with the development of artificial intelligence (AI) technology. For example, when the NPC is an enemy soldier, a plurality of NPCs form a group. The NPCs autonomously break up in the game space, and surround the player's character while hiding themselves behind an obstacle. The movement of the NPC changes depending on the game state.

On the other hand, the player of a gun shooting game who desires further excitement and reality tends to prefer a situation in which a number of NPCs appear in a battlefield at one time and the player's character successively shoots a machine gun at the NPCs.

In a gun shooting game in which a number of NPCs autonomously move and attack the player's character, since the virtual camera is normally controlled to display the main object NPC at the center of the screen, other NPCs may not be displayed on the screen. Therefore, the player who desires to shoot the targets one after another may not easily determine the targets so that the player may not be able to enjoy a refreshing game. Moreover, since the radius of the virtual sphere is increased as the number of NPCs increases, the virtual camera necessarily photographs a wide range of the game space. Therefore, a number of NPCs are unnecessarily displayed on the screen. This makes it difficult for the player to take aim at the target.

### SUMMARY

According to one aspect of the invention, there is provided a method that is implemented by a processor, the method comprising:

causing a plurality of enemy groups to appear in a battle area, each of the plurality of enemy groups being formed by one or more enemy non-playable characters (NPCs);

selecting an object enemy group from the plurality of enemy groups;

selecting an enemy NPC that is included within a viewing area from the one or more enemy NPCs that form the object enemy group;

calculating a photographing reference point based on a position of the enemy NPC that is included within the viewing area;

aiming a photographing direction of a virtual camera at the photographing reference point; and

generating an image using the virtual camera.

According to another aspect of the invention, there is provided a method that is implemented by a processor, the method comprising:

causing a plurality of enemy groups to appear in a battle area, each of the plurality of enemy groups being formed by one or more enemy non-playable characters (NPCs);

selecting an object enemy group from the plurality of enemy groups;

controlling a virtual camera while setting the object enemy group as a photographing target; generating an image using the virtual camera;

calculating a damage state of the object enemy group; and

selecting a new object enemy group when the damage state of the object enemy group has satisfied a given condition.

### BRIEF DESCRIPTION OF THE DRAWINGS

FIG. 1 is an external view illustrative of a configuration example of a gun shooting game device.

FIG. 2 is a view showing an example of a game screen.

FIG. 3 is a view showing the relative positional relationship between a player's character and a virtual camera.

FIG. 4 is a schematic overhead view of a game space illustrative of a configuration example of a game space.

FIG. 5 is a view illustrative of the principle of setting a photographing direction and an angle of view.

FIG. 6 is another view illustrative of the principle of setting a photographing direction and an angle of view.

FIG. 7 is a further view illustrative of the principle of setting a photographing direction and an angle of view.

FIG. 8A is a view showing an example of a game screen during a first additional control process, and FIG. 8B is a view showing the relative relationship between a virtual camera CM and an enemy NPC 4 that belongs to an object group during a first additional control process.

FIG. 9A is a view showing an example of a game screen during the first additional control process, and FIG. 9B is a view showing the relative relationship between a virtual camera CM and an enemy NPC 4 that belongs to an object group during the first additional control process.

FIG. 10 is a view illustrative of a second additional control process.

FIG. 11 is another view illustrative of the second additional control process.

FIG. 12 is a further view illustrative of the second additional control process.

FIG. 13 is another view illustrative of a third additional control process.

FIG. 14 is a functional block diagram showing a functional configuration example.

FIG. 15 is a view showing a data configuration example of character initial setting data.

FIG. 16 is a view showing a data configuration example of script data.

FIG. 17 is a view showing a data configuration example of attack priority setting data.

FIG. 18 is a flowchart illustrative of the flow of a main process.

FIG. 19 is a flowchart illustrative of the flow of a virtual camera automatic control process.

FIG. 20 is a flowchart illustrative of the flow of a special camera work control process.

FIG. 21 is a view showing a configuration example of a consumer game device.

FIG. 22 is a view illustrative of a modification of a virtual camera control process that changes a photographing position in place of an angle of view.

### DESCRIPTION OF EXEMPLARY EMBODIMENTS

The invention may enable the virtual camera to be appropriately controlled so that an easily viewable screen is displayed even if a number of NPCs appear one after another.

According to one embodiment of the invention, there is provided a method that is implemented by a processor, the method comprising:

causing a plurality of enemy groups to appear in a battle area, each of the plurality of enemy groups being formed by one or more enemy non-playable characters (NPCs);

selecting an object enemy group from the plurality of enemy groups;

selecting an enemy NPC that is included within a viewing area from the one or more enemy NPCs that form the object enemy group;

calculating a photographing reference point based on a position of the enemy NPC that is included within the viewing area;

aiming a photographing direction of a virtual camera at the photographing reference point; and

generating an image using the virtual camera.

According to another embodiment of the invention, there is provided a computer device comprising:

an enemy control section that causes a plurality of enemy groups to appear in a battle area and controls an enemy non-playable character (NPC), each of the plurality of enemy groups being formed by one or more enemy NPCs;

an object selection section that selects an object enemy group from the plurality of enemy groups;

a viewing area selection section that selects an enemy NPC that is included within a viewing area from the one or more enemy NPCs that form the object enemy group;

a reference point calculation section that calculates a photographing reference point based on a position of the enemy NPC that is included within the viewing area;

a virtual camera control section that aims a photographing direction of a virtual camera at the photographing reference point; and

an image generation section that generates an image using the virtual camera.

According to the above configuration, the object enemy group is selected from the plurality of enemy groups that appears in the current battle area, and the virtual camera can be aimed at the photographing reference point calculated based on the position of the enemy NPC selected from the enemy NPCs that form the object enemy group.

Specifically, since a game screen that follows the enemy NPC group selected from a number of enemy NPC groups can be displayed, the player can shoot the enemy NPCs within the field of view one after another. Therefore, the player can enjoy refreshing game play. The term “group” used herein includes a case where a group is formed by a single enemy NPC.

The method may further comprise:

controlling an angle of view of the virtual camera based on the position of the enemy NPC that is included within the viewing area.

According to the above configuration, the state of the enemy NPCs that form the object enemy group can be displayed on the game screen at one time.

In the method,

photographing target information that indicates whether or not include a corresponding enemy NPC within the viewing area may be defined in advance corresponding to each of the enemy NPCs; and

the selecting of the enemy NPC may include selecting the enemy NPC based on the photographing target information.

According to the above configuration, the virtual camera can be controlled so that the enemy NPCs selected based on the photographing target information are selectively photographed, instead of photographing all of the enemy NPCs that form the object enemy group. Therefore, even if the enemy group is deployed along a transverse direction of the screen, a situation in which the angle of view is significantly increased so that the enemy NPC displayed on the screen becomes too small can be prevented by appropriately excluding the enemy NPC positioned on the end from the photographing target. Specifically, the above effects can be reliably achieved even if the enemy group is deployed over a wide range of the game space.

The method may further comprise:

moving a player's character to a new battle area when a given clear condition that is defined in advance corresponding to each battle area has been satisfied; and

selecting a new object enemy group from other enemy groups that are positioned in the battle area when the object enemy group has been defeated and the given clear condition has not been satisfied.

The expression “the enemy group has been defeated” used herein refers to a state in which the threat of the enemy group has been removed in the game world. The state in which the threat of the enemy group has been removed may be appropriately set corresponding to the game (e.g., a state in which the enemy group has been completely defeated, a state in which some of the enemy NPCs remain undefeated, a state in which the enemy group has been persuaded to surrender, a state in which the enemy group has fallen asleep or has been paralyzed due to an item or magic, or a state in which the damage level of the enemy group has reached a reference value).

According to the above configuration, even if the object enemy group has been defeated in the current battle area, another enemy group that is positioned in the current battle area can be automatically selected as a new object. Specifically, since the object enemy groups are automatically displayed on the game screen one after another until the current game stage ends, the player can very easily play the game.

In the method,

the selecting of the new object enemy group may include selecting the new object enemy group based on a priority that is set corresponding to each of the plurality of enemy groups.

According to the above configuration, since the enemy NPC groups can be displayed on the game screen one after another in the order of priority, a game screen that allows the player to easily play the game can be provided.

The method may further comprise:

calculating a damage state of each of the plurality of enemy groups; and

selecting a new object enemy group when the damage state of the object enemy group has satisfied a given condition.

The term “damage state” used herein refers to the damage level that corresponds to a value decremented from the hit point of the enemy NPC, or a state (or a parameter that indicates the state) in which the combat capability decreases (e.g., a paralysis state, a sleep state, or a confusion state), and may be appropriately set corresponding to the game.

According to the above configuration, the enemy group for which the damage state satisfies a given condition can be excluded from the object based on damage to the entire enemy group, and a new object can be selected and displayed on the screen. Therefore, the player can more easily play the game.

According to another embodiment of the invention, there is provided a method that is implemented by a processor, the method comprising:

causing a plurality of enemy groups to appear in a battle area, each of the plurality of enemy groups being formed by one or more enemy non-playable characters (NPCs);

selecting an object enemy group from the plurality of enemy groups;

controlling a virtual camera while setting the object enemy group as a photographing target;

generating an image using the virtual camera;

calculating a damage state of the object enemy group; and

selecting a new object enemy group when the damage state of the object enemy group has satisfied a given condition.

According to another embodiment of the invention, there is provided a computer device comprising:

an enemy control section that causes a plurality of enemy groups to appear in a battle area and controls an enemy non-playable character (NPC), each of the plurality of enemy groups being formed by one or more enemy NPCs;

an object selection section that selects an object enemy group from the plurality of enemy groups;

a virtual camera control section that controls a virtual camera while setting the object enemy group as a photographing target;

an image generation section that generates an image using the virtual camera; and

a state calculation section that calculates a damage state of the object enemy group,

the object selection section selecting a new object enemy group when the damage state of the object enemy group calculated by the state calculation section has satisfied a given condition.

According to the above configuration, the object enemy group is selected from the plurality of enemy groups that appears in the current battle area, and the virtual camera can be aimed at the enemy NPC selected from the enemy NPCs that form the object enemy group. Moreover, the enemy group for which the damage state satisfies a given condition can be excluded from the object based on damage to the entire enemy group, and a new object can be selected and displayed on the screen.

Specifically, since a game screen that automatically follows the enemy NPC group selected from a number of enemy NPC groups can be displayed, the player can shoot the enemy NPCs within the field of view one after another. Therefore, the player can enjoy refreshing game play.

The method may further comprise:

selecting a new object enemy group when a given event has occurred during a game.

According to the above configuration, an object appropriate for a new game state that has occurred due to an event can be automatically selected and displayed on the game screen.

The method may further comprise:

selecting an enemy NPC among the one or more enemy NPCs that form the object enemy group as a focus NPC when the one or more enemy NPCs that form the object enemy group are not photographed within a given center range of the image using the virtual camera; and

correcting a photographing direction and an angle of view of the virtual camera so that the focus NPC is photographed within the given center range.

According to the above configuration, a situation in which the enemy NPC of the object enemy group is displayed only on the end of the screen can be detected, and the photographing direction and the angle of view can be automatically corrected so that the enemy NPC is displayed within the given center range of the screen.

The method may further comprise:

controlling the virtual camera so that the focus NPC and another NPC that is positioned within a given range around the focus NPC are photographed within the given center range.

According to the above configuration, when another enemy NPC is positioned near the focus NPC, the other enemy NPC can be displayed within the given center range of the screen together with the focus NPC. Therefore, a screen that allows the player to more easily play the game can be implemented.

The method may further comprise:

correcting a photographing direction and an angle of view of the virtual camera so that a current object enemy group and a given priority enemy group are photographed when the priority enemy group has appeared in the battle area and is positioned within the viewing area.

According to the above configuration, when a priority enemy group with a priority higher than that of the object enemy group has appeared and entered the current battle area, the object enemy group and the priority enemy group are photographed by the virtual camera. Therefore, the player can be notified of the appearance of the priority enemy group together with the relative positional relationship between the priority enemy group and the current object enemy group.

The method may further comprise:

controlling the virtual camera while setting the priority enemy group as a new object enemy group after correcting the photographing direction and the angle of view of the virtual camera so that the current object enemy group and the priority enemy group are photographed.

According to the above configuration, the virtual camera can be automatically controlled so that the object is updated with the enemy group with a high priority and displayed on the screen.

In the method,

the virtual camera may be set as a first-person viewpoint of a player's character; and

the method may further comprise controlling the virtual camera while setting an enemy NPC that has entered a given adjacent range or an enemy group to which the enemy NPC that has entered the adjacent range belongs as an object, the adjacent range being formed around the virtual camera or the player's character.

According to the above configuration, the enemy NPC that has approached the player's character can be preferentially displayed on the screen by updating the object with the enemy NPC that has approached the player's character or the enemy group to which the enemy NPC that has approached the player's character belongs. Moreover, the state of the group can also be displayed on the screen. Therefore, the player can deal with the enemy NPC that has approached the player's character and can determine the state of the group to which the enemy NPC belongs. This makes it possible for the player more easily play the game.

According to another embodiment of the invention, there is provided a computer-readable storage medium storing a program that causes a computer device to execute one of the above methods.

The term “storage medium” used herein includes a magnetic disk, an optical disk, an IC memory, and the like.

Exemplary embodiments to which the invention is applied are described below. The following description illustrates an example in which a computer device is an arcade game device. Note that the computer device may be a consumer game device, a personal computer, or the like.

### First Embodiment

A first embodiment to which the invention is applied is described below taking an example of an arcade gun shooting game device that allows the player to play a first-person gun shooting game.

Configuration of Game Device

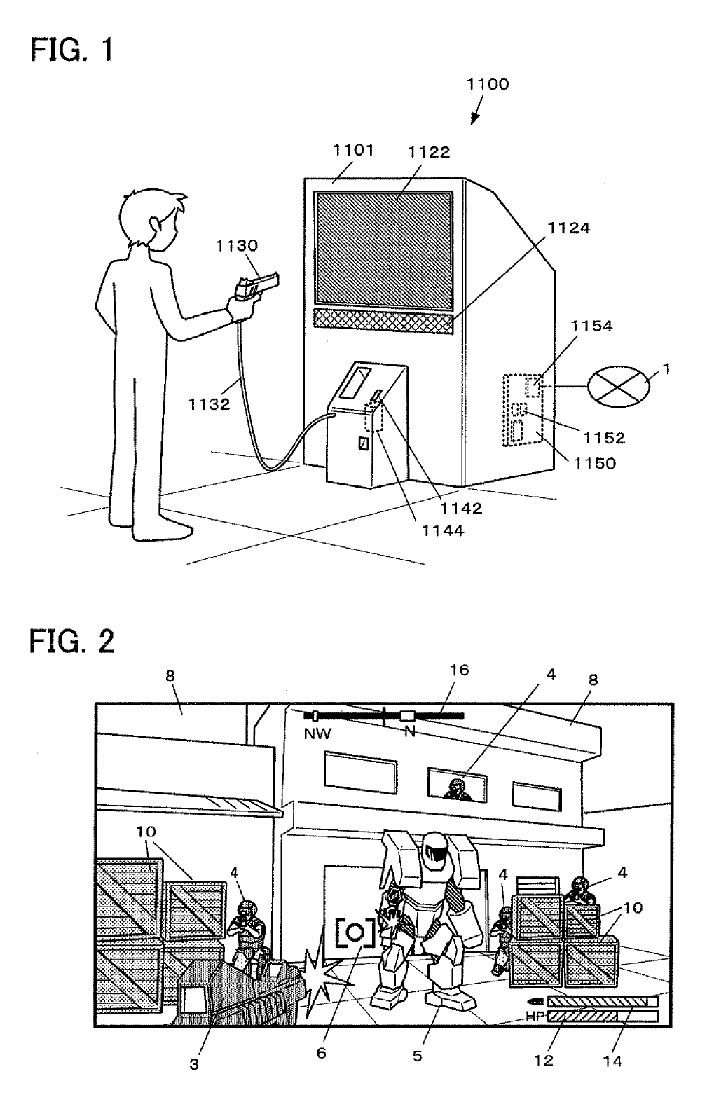

FIG. 1 is an external view illustrative of a configuration example of a gun shooting game device 1100. The gun shooting game device 1100 may be implemented by a game device used for “Time Crises 4” (developed by Namco Bandai Games, Inc.), for example. The gun shooting game device 1100 includes a gun-type controller 1130 that imitates a gun, an image display device 1122, a speaker 1124, a coin detection sensor 1144 that detects a coin inserted into a coin insertion slot 1142, and a control unit 1150 that are provided in a main body 1101.

The control unit 1150 corresponds to a game device control board, and includes various processors (e.g., central processing unit (CPU), graphics processing unit (GPU), and digital signal processor (DSP)), an application-specific integrated circuit (ASIC), and various IC memories (e.g., VRAM, RAM, and flash memory 1152). The control unit 1150 also includes a communication device 1154, a driver circuit that drives the image display device 1122, an amplifier circuit that outputs a sound signal to the speaker 1124, and an interface circuit (I/F circuit) such as a signal input-output circuit that exchanges signals with the gun-type controller 1130 and the coin detection sensor 1144. The elements provided in the control unit 1150 are electrically connected through a bus circuit so that the elements can read/write data and transmit/receive a signal.

The flash memory 1152 stores a program and setting data necessary for the control unit 1120 to execute game play-related calculations. When the coin detection sensor 1144 has detected that a given amount of coin has been inserted, the control unit 1150 reads a program and data from the flash memory 1152, and temporarily stores the program and data in the IC memory. The control unit 1150 then executes the program read from the flash memory 1152 to generate a game image and a game sound. The game image is displayed on the image display device 1122, and the game sound is output from the speaker 1124.

The player stands in front of the image display device 1122 (screen), and aims the gun-type controller 1130 at the image display device 1122. A target and a sight 6 that indicates the position at which the player aims using the gun-type controller 1130 are displayed on the game screen. The player enjoys the shooting game while holding the gun-type controller 1130 so that the sight 6 coincides with an arbitrary target displayed on the game screen, and pulling the trigger (shooting operation), for example.

Although this embodiment employs a configuration in which a necessary program and setting data are read from the flash memory 1152, it is also possible to employ a configuration in which the communication device 1154 connects to a cable/wireless communication channel 1 (e.g., Internet, local area network (LAN), or wide area network (WAN)), and downloads a necessary program and setting data from an external device.

Outline of Game

FIG. 2 is a view showing an example of a game screen according to this embodiment. In this embodiment, a game space (battlefield) is formed by disposing obstacle objects such as a building 8 and a wooden box 10 in a virtual three-dimensional space, and character objects such as a player's character, an enemy NPC 4 (i.e., target), and a special enemy NPC 5 (i.e., target) are disposed and operated in the game space. The appearance positions and the operations of the enemy NPC 4 and the special enemy NPC 5 are determined in advance based on script data or are AI-controlled so that the enemy NPC 4 and the special enemy NPC 5 approach and attack a player's character 2.

A gun 3 displayed at the lower left of the screen is a weapon possessed by the player's character. Specifically, the game screen according to this embodiment is generated from the first person point of view of the player's character.

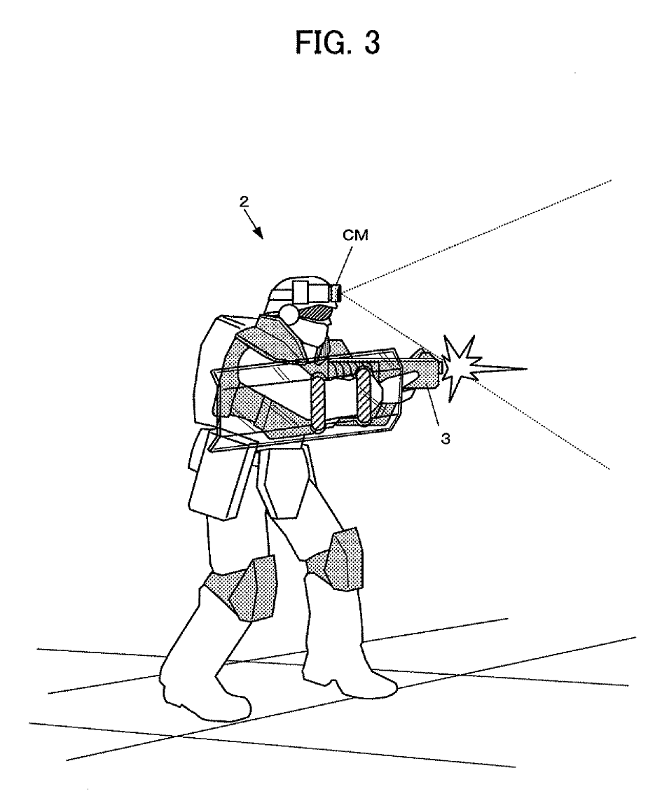

As shown in FIG. 3, a virtual camera CM is provided so that the photographing direction of the virtual camera CM coincides with the line-of-sight direction of the player's character 2. The movement and the line-of-sight direction of the player's character 2 are automatically controlled so that the player's character 2 moves within the game space along a given path and gazes at the enemy NPC 4 (attack direction) at a given attack point (i.e., the player cannot arbitrarily move the player's character 2 in the game space, or cannot arbitrarily change the direction (i.e., line of sight) of the virtual camera). Note that the invention is not limited thereto.

A game space image (3D CG image) (i.e., an image of the game space photographed using the virtual camera CM from the first person point of view of the player's character 2) is generated. A game screen is generated by synthesizing the game space image with various information indicators such as a hit point gauge 12 that indicates the hit point of the player's character 2, a bullet gauge 14 that indicates the number of bullets loaded, a direction indicator 16 that indicates the line-of-sight direction, and the sight 6 that indicates the position at which the player aims using the gun-type controller 1130. The game screen thus generated is displayed on the image display device 1122. The image display device 1122 displays a situation in which the enemy attacks the player's character 2 while the player's character 2 runs through the battlefield. The player aims the sight 6 at the enemy NPC 4 and shoots the enemy NPC 4 before the enemy NPC 4 attacks the player's character 2.

FIG. 3 shows a state in which the body object of the player's character 2 is displayed. Note that the body object of the player's character 2 may not be displayed when the player's character 2 does not appear on the game screen. Specifically, the player's character 2 may be formed by only the virtual camera CM and the object of the gun 3 that is displayed on the edge of the screen.

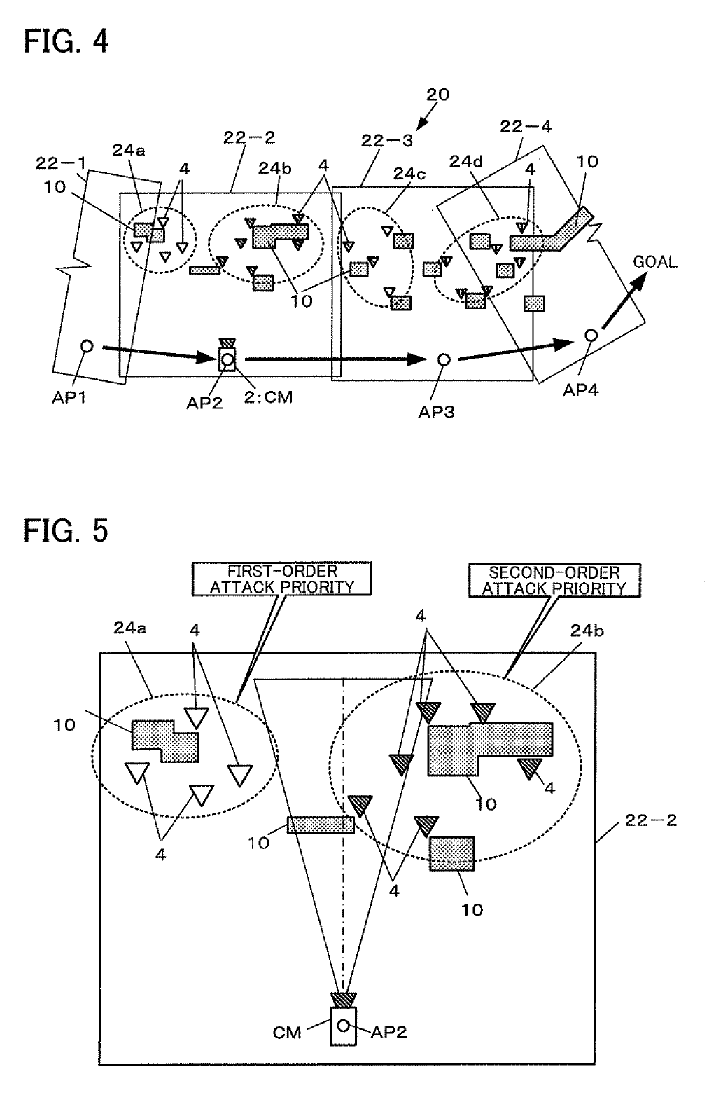

FIG. 4 is a schematic overhead view of the game space that is illustrative of a configuration example of the game space according to this embodiment. As shown in FIG. 4, a game space 20 includes a plurality of battle areas 22 (22-1, 22-2, . . . ). Each battle area 22 corresponds to a game stage.

The player's character 2 (virtual camera CM) moves to a given battle position AP (AP1, AP2, . . . ) set within the battle area 22, and shoots a plurality of enemy groups 24 (24a, 24b, . . . ) that appear in the battle area 22. A plurality of enemy NPCs 4 are included in each enemy group 24 (corresponding to one or more platoons).

When the player's character 2 has defeated all of the enemy groups 24 that appear in the battle area 22, the player's character 2 clears the battle area 22 (i.e., game stage), moves to the adjacent battle area 22, and fights against the enemy groups 24 that appear in that battle area 22. This process is repeated until the player's character 2 reaches a given goal point.

In this embodiment, the hit point of the player's character is decremented when the enemy NPC 4 has attacked the player's character in the same manner as in a known gun shooting game. The player clears the game when the player's character has reached a given goal point before the hit point reaches “0”, otherwise the game ends (game over).

The term “defeat” used herein refers to gaining military supremacy over the enemy group, and includes a case where a small number of enemy NPCs 4 that belong to the enemy group remain undefeated.

The player's character 2 fights against the enemy group in a location around a given battle position. The photographing direction and the angle of view of the virtual camera CM are appropriately adjusted so that the game screen displayed from the viewpoint of the player's character 2 allows the player to easily play the game.

The photographing direction and the angle of view of the virtual camera CM may be set so that the entire battle area 22 can be photographed. In this case, the game screen changes to only a small extent, and the size of the enemy NPC 4 displayed on the game screen decreases. Therefore, excitement of the game may be impaired. Moreover, the game playability may be impaired.

In this embodiment, the main object group (object group) is selected from the enemy groups 24 that appear in the battle area 22 based on the attack priority assigned to each group, and the photographing direction and the angle of view of the virtual camera CM are adjusted so that the entire main object group can be photographed. The term “main object” means that an enemy NPC that belongs to another group may also be displayed on the game screen depending on the deployment of the enemy NPCs and the photographing conditions.

Principle of setting photographing direction and angle of view

FIGS. 5 to 7 are views illustrative of the principle of setting the photographing direction and the angle of view according to this embodiment. Note that FIGS. 5 to 7 are enlarged views of the battle area 22-2 shown in FIG. 4.

In the example shown in FIG. 5, since an attack priority higher than that of a second group 24b is assigned to the first group 24a, the first group 24a is selected as the object group when the number of object groups is “1” (the number of object groups may be two or more).

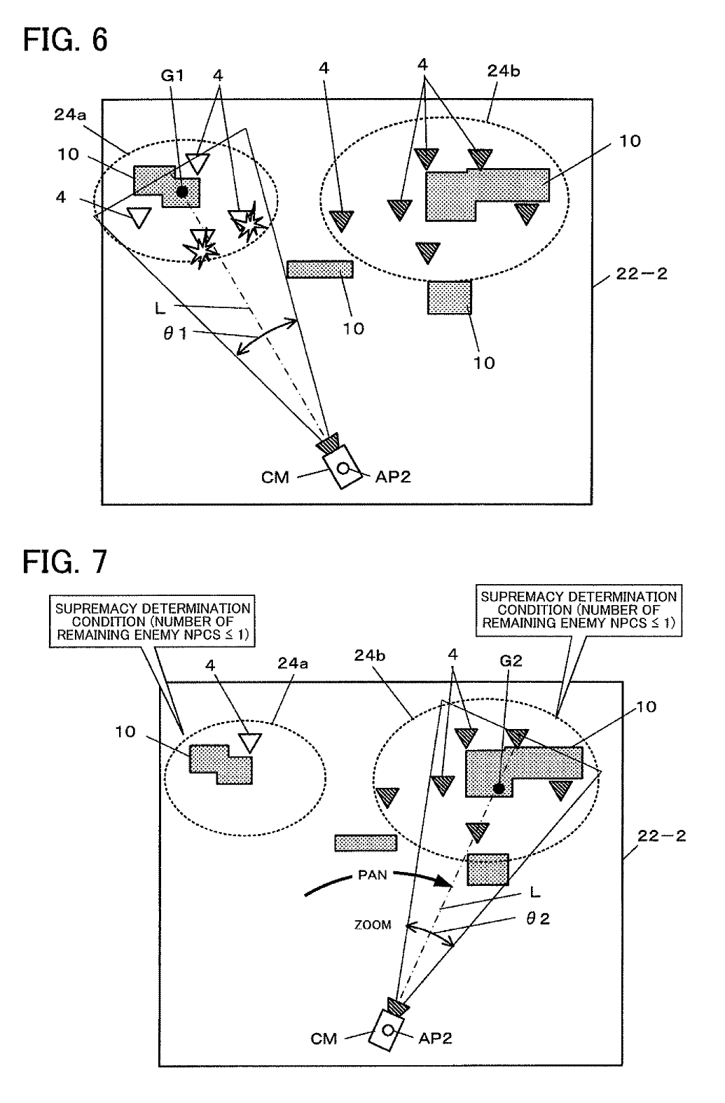

As shown in FIG. 6, a reference point G1 that corresponds to the representative point of the enemy NPCs included in the object group is calculated based on the position coordinates of the enemy NPCs 4 included in the object group. The reference point G1 may be calculated as the center-of-gravity position of a polygon formed by connecting the positions of the enemy NPCs 4, or may be calculated as the average value of the position coordinates of the enemy NPCs 4, for example. A target angle of view θ1 at which the enemy NPCs 4 included in the object group are positioned within the viewing area when the photographing direction L of the virtual camera CM aims at the reference point G1 is calculated, and the virtual camera CM is controlled so that the angle of view coincides with the target angle of view θ1 while the photographing direction L aims at the reference point G1. The target angle of view is preferably calculated so that the enemy NPCs to be photographed are displayed as large as possible within a safe area.

Therefore, only the enemy NPCs 4 that belong to the first group 24a among a number of NPCs that appear in the battle area 22-2 are displayed on the game screen that is generated based on an image using the virtual camera CM thus controlled. The size of the enemy NPC 4 displayed on the game screen can be appropriately adjusted by appropriately setting the number of enemy NPCs that belong to one group, so that a game screen that allows the player to easily select the target can be provided.

When the player has shot the enemy NPCs 4 displayed on the game screen, the enemy NPCs 4 that have been shot fall one after another in the same manner as in a known gun shooting game. When the number of remaining enemy NPCs 4 has satisfied a given defeat determination condition defined for the first group 24a, it is determined that the first group 24a has been defeated (i.e., the threat of the first group 24a has been removed), and a new object group is selected from the remaining enemy groups based on the attack priority.

In the example shown in FIG. 7, since a defeat determination condition “number of remaining enemy NPCs≦1” is defined for the first group 24a, it is determined that the first group 24a has been defeated although one enemy NPC 4 that belongs to the first group 24a remains undefeated, and the first group 24a is canceled from the object group.

The second group 24b to which the second-order attack priority is assigned is then selected, and the object group is updated. A reference point G2 of the updated object group and a target angle of view θ2 at which the enemy NPCs 4 that belong to the object group can be photographed are calculated in the same manner as described above.

The target angle of view is basically calculated based on the deployment of all of the enemy NPCs 4 that belong to the object group. Note that the target angle of view may be calculated without taking account of some of the enemy NPCs 4. In the example shown in FIG. 7, the leftmost enemy NPC with respect to the virtual camera CM is excluded from the target angle of view calculation target. A situation in which some of the enemy NPCs 4 are positioned away from other enemy NPCs 4 so that the target angle of view widens to a large extent can be prevented by excluding some of the enemy NPCs 4 from the target angle of view calculation target. This preferably applies to an AI-controlled enemy NPC 4, for example. For example, when an abducted civilian is included in the enemy group as a non-attackable NPC, a game screen that allows the player to easily play the game without shooting the non-attackable NPC by mistake can be implemented by excluding the non-attackable NPC from the target angle of view calculation target.

When the reference point 62 and the target angle of view θ2 have been calculated, the virtual camera CM is panned so that the photographing direction L aims at the reference point G2, and is zoom-controlled so that the angle of view coincides with the target angle of view θ2. In the example shown in FIG. 7, when the player has defeated the first group 24a, the virtual camera CM is automatically controlled to photograph the second group 24b that includes the next attack targets. Therefore, the next attack target group in the current game stage is automatically displayed on the game screen (i.e., an appropriate screen change occurs). Since the size of the enemy NPCs 4 displayed on the game screen can be appropriately adjusted by appropriately setting the number of enemy NPCs 4 that belong to the second group 24b, a game screen that allows the player to easily select the target can be generated.

In this embodiment, the virtual camera is additionally controlled as described below in order to provide a game screen that allows the player to more reliably play the game depending on the game state.

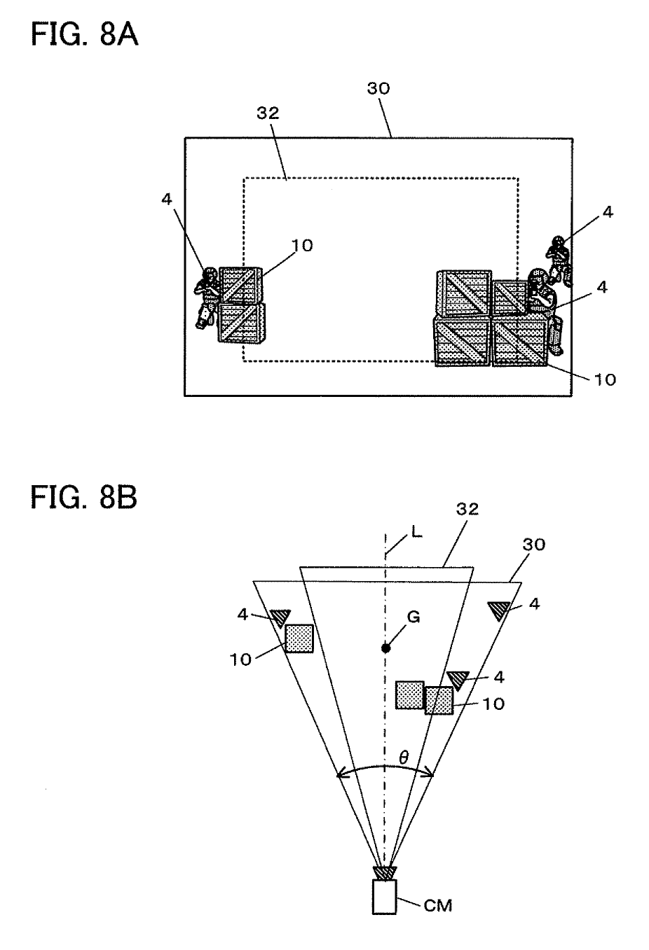

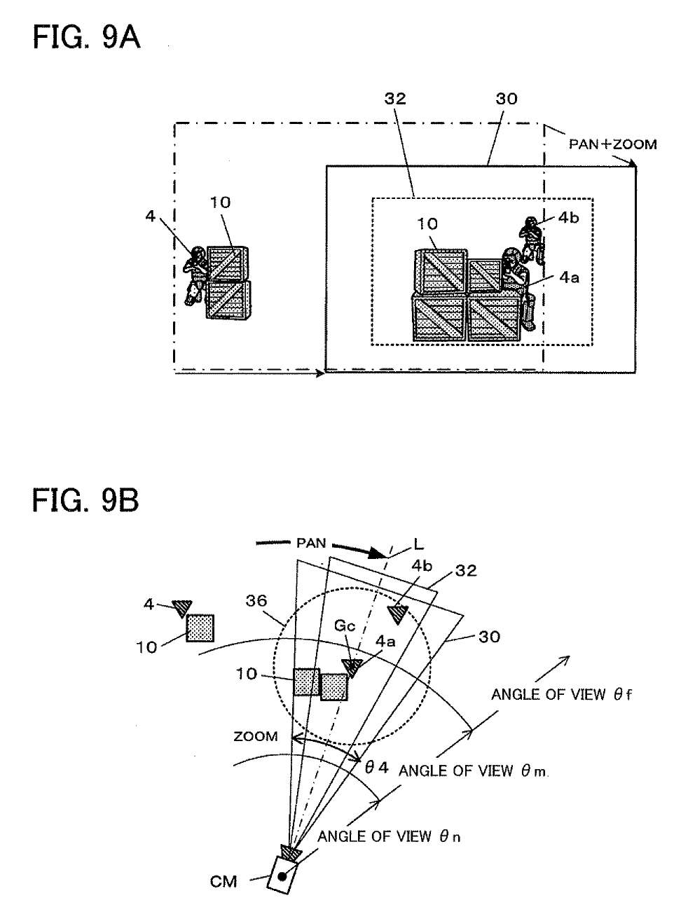

FIGS. 8A to 9B are views illustrative of a first additional control process. FIGS. 8A and 9A are views showing examples of the game screen, and FIGS. 8B and 9B are schematic overhead views shown in the relative relationship between the virtual camera CM and the enemy NPCs 4 that belong to the object group. The virtual camera CM is basically controlled so that the entire object group is photographed. However, when the enemy NPCs 4 that belong to the object group are not displayed within a main viewing area 32 that is set in advance at the center of a full viewing area 30 on the game screen (e.g., the enemy NPC 4 attacked by the player's character 2 has been defeated) (see FIG. 8A), the player may not easily play the game since the targets are positioned near the edge of the screen. Therefore, a control mode that photographs the entire enemy group is canceled and changed to a control mode that photographs a given enemy NPC 4 so that an arbitrary enemy NPC 4 is displayed within the main viewing area 32.

As shown in FIG. 9B, an enemy NPC 4a that is nearest to the virtual camera CM is selected as the object. Specifically, the virtual camera CM is panned so that the photographing direction L aims at a representative point Gc of the enemy NPC 4a selected as the object. The target angle of view is selected from angles of view θn, θm, and θf set in advance corresponding to the distance between the enemy NPC 4a selected as the object and the virtual camera CM, and the virtual camera CM is zoom-controlled so that the angle of view coincides with the selected target angle of view (the angle of view θm in the example shown in FIG. 9B). When another enemy NPC 4b that belongs to the same group as the enemy NPC 4a is present within a given adjacent NPC search area 36 formed around the enemy NPC 4a selected as the object, a target angle of view θ4 is calculated so that the enemy NPC 4b is displayed within the main viewing area 32, and the virtual camera CM is zoom-controlled so that the angle of view coincides with the target angle of view θ4.

As a result, a game screen that allows the player to easily play the game is automatically generated by displaying the enemy NPC 4a and the enemy NPC 4b that belong to the object group within the main viewing area 32 on the game screen, as shown in FIG. 9B.

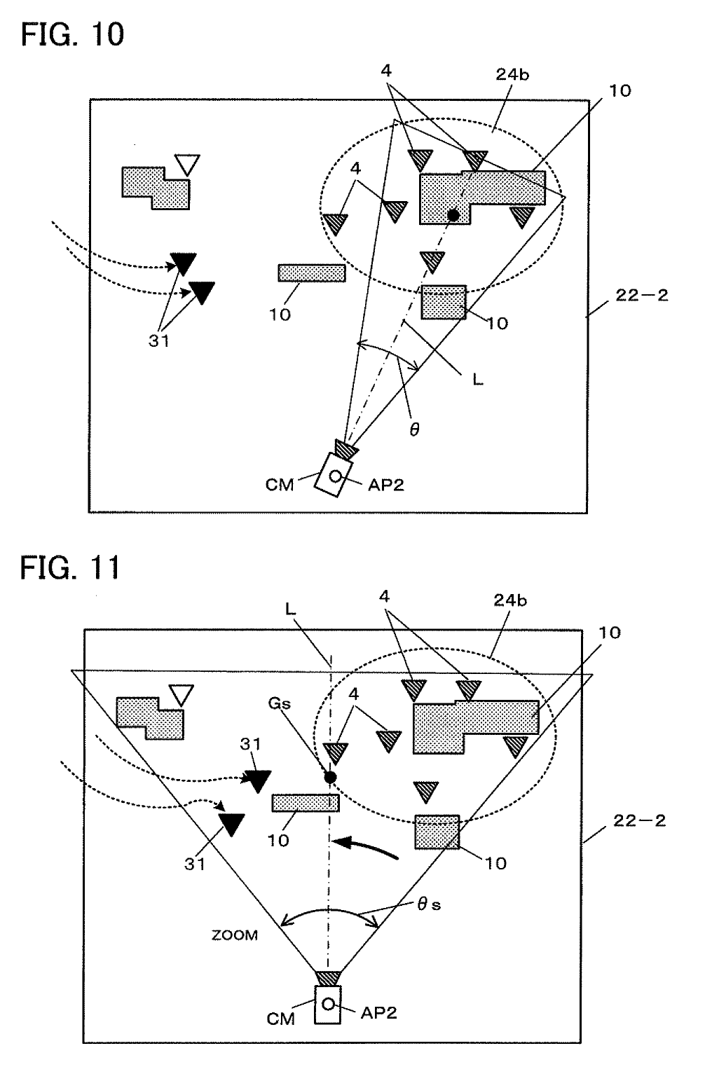

FIGS. 10 to 12 are schematic overhead views of the battle area 22-2 illustrative of a second additional control process. In this embodiment, a special enemy NPC 31 to which an attack priority higher than those of the enemy groups 24 is assigned appears in a given game stage.

In the second additional control process, when an enemy NPC or an enemy group to which an attack priority higher than that of the current object group is assigned has appeared, a special camera work is performed in order to notify the player of the appearance of the enemy NPC or enemy group to which an attack priority higher than that of the current object group is assigned. The enemy NPC that has appeared is selected as a new object, and the photographing direction L and the angle of view θ of the virtual camera CM are readjusted.

As shown in FIG. 10, the special enemy NPCs 31 appear in the current battle area 22-2 when the second group 24b is photographed by the virtual camera CM as the object group, for example. Since only the enemy NPCs 4 that belong to the second group 24b are displayed on the game screen, the player cannot determine that the special enemy NPCs 31 have appeared.

In this case, as shown in FIG. 11, a special reference point Gs is calculated based on the enemy NPCs 4 that belong to the current object group (second group 24b) and the special enemy NPCs 31, and a special target angle of view θs at which the enemy NPCs 4 that belong to the current object group and the special enemy NPCs 31 can be photographed when the photographing direction L of the virtual camera CM aims at the special reference point Gs is calculated (special camera work). The virtual camera CM is then panned so that the photographing direction L aims at the reference point Gs, and zoom-controlled so that the angle of view coincides with the special target angle of view θs.

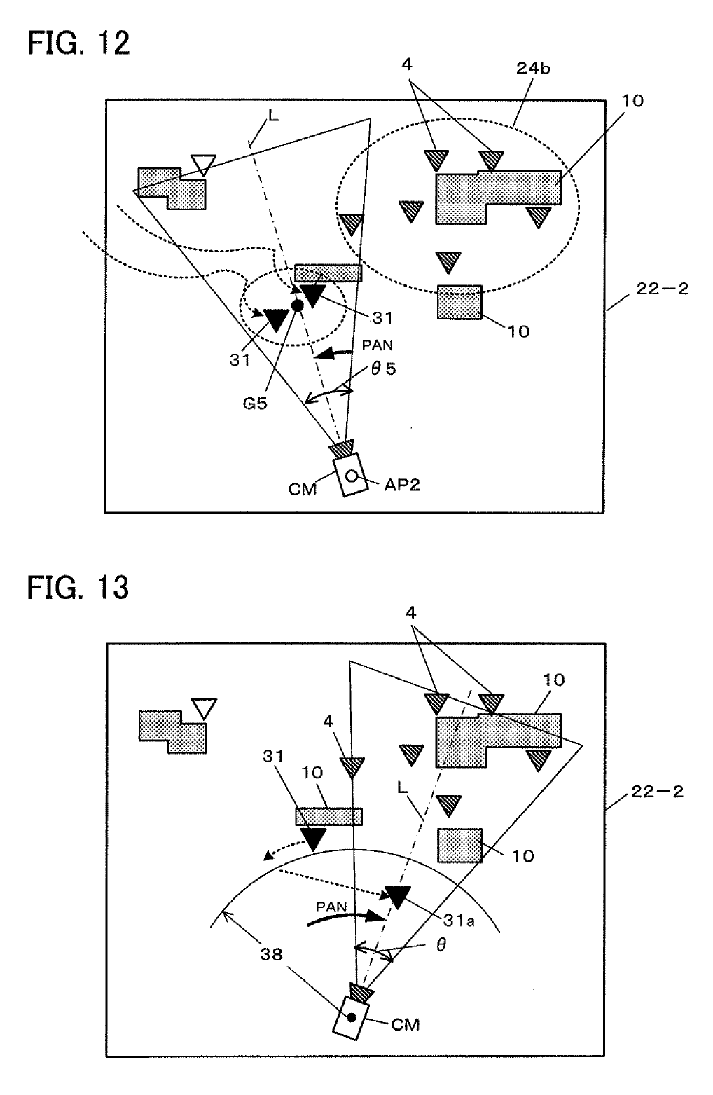

As shown in FIG. 12, the special enemy NPCs 31 are selected as a new object group, and a reference point G5 and a target angle of view θ5 are calculated. The virtual camera CM is then panned and zoom-controlled so that the photographing direction L aims at the reference point θ5, and the angle of view coincides with the target angle of view θ5.

Therefore, the player can be notified of the appearance of the special enemy NPCs 31 together with the relative positional relationship to the preceding target group. The object can be promptly updated with the special enemy NPCs 31 with a higher attack priority and displayed on the game screen.

FIG. 13 is a schematic overhead view of the battle area 22-2 illustrative of a third additional control process. In the third additional control process, when a special enemy NPC 31a has entered a given adjacent attack range 38 around the virtual camera CM (may be the player's character), the special enemy NPC 31a is set to be a new object, and the virtual camera CM is panned so that the photographing direction L aims at the representative point of the special enemy NPC 31a and the special enemy NPC 31a is displayed within the main viewing area 32. The target angle of view is selected from the angles of view θn, θm, and θf corresponding to the relative distance between the virtual camera CM and the special enemy NPC 31a in the same manner as in FIG. 9B, and the virtual camera CM is zoom-controlled so that the angle of view coincides with the selected target angle of view.

Specifically, the special enemy NPC 31a that is positioned closest to the player's character is determined to be the greatest threat, and a screen that allows the player to easily aim at the special enemy NPC 31a is generated.

In this embodiment, the third additional control process is performed on the special enemy NPC. Note that the third additional control process may also be performed on the normal enemy NPC.

Functional Blocks

A functional configuration that implements the above features is described below.

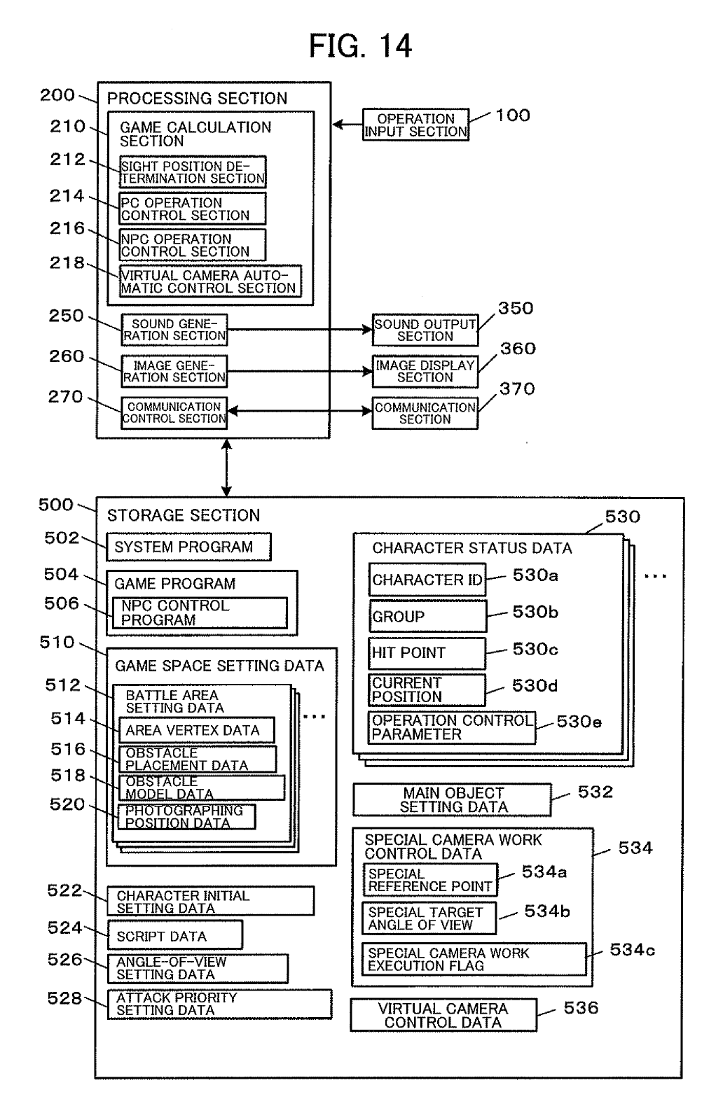

FIG. 14 is a functional block diagram showing an example of the functional configuration according to this embodiment. As shown in FIG. 14, the gun shooting game device 1100 according to this embodiment includes an operation input section 100, a processing section 200, a sound output section 350, an image display section 360, a communication section 370, and a storage section 500.

The operation input section 100 outputs an operation input signal to the processing section 200 based on an operation input performed by the player. The function of the operation input section 100 may be implemented by a button switch, a joystick, a touch pad, a trackball, a multi-axis acceleration sensor that has two or more detection axes, a single-axis acceleration sensor unit formed by combining acceleration sensors so that the detection axis direction differs, a multi-direction tilt sensor that has two or more detection directions, a single-direction tilt sensor unit formed by combining tilt sensors so that the detection direction differs, a video camera that photographs a deviation from a reference position, and the like. In FIG. 1, the gun-type controller 1130 corresponds to the operation input section 100.

The processing section 200 is implemented by electronic components such as a microprocessor (e.g., CPU and GPU), an application-specific integrated circuit (ASIC), and an IC memory. The processing section 200 exchanges data with each functional section. The processing section 200 controls the operation of the gun shooting game device 1100 by performing various calculations based on a given program, data, and the operation input signal input from the operation input section 100. In FIG. 1, the control unit 1150 corresponds to the processing section 200 (i.e., computer board).

The processing section 200 according to this embodiment includes a game calculation section 210, a sound generation section 250, an image generation section 260, and a communication control section 270.

The game calculation section 210 executes a game process. For example, the game calculation section 210 disposes obstacle objects (e.g., a building 8 and a wooden box 10) and the like in the virtual three-dimensional space to form a game space, disposes the character objects (e.g., player's character 10 and enemy NPC 4) in the game space, controls the operations of the characters disposed in the game space, controls the movements and the attack operations of the characters disposed in the game space, determines whether or not an object has hit another object due to attack or the like (whether or not a bullet has hit a character), performs physical calculations, and calculates the game result.

The game calculation section 210 according to this embodiment includes a sight position determination section 212, a player's character (PC) operation control section 214, an NPC operation control section 216, and a virtual camera automatic control section 218.

The sight position determination section 212 determines the coordinates of the sight position in the game screen coordinate system indicated by the operation input section 100. Specifically, the sight position determination section 212 calculates the position on the screen (image display device 1122) indicated by the muzzle of the gun-type controller 1130. The sight position determination section 212 calculates the sight position in the virtual three-dimensional space from the position on the screen indicated by the muzzle of the gun-type controller 1130 to determine the direction of the muzzle of the gun-type controller 1130. The function of the sight position determination section 212 may be implemented by utilizing known gun shooting game device technology.

The PC operation control section 214 controls the operation of the player's character 2. Specifically, the PC operation control section 214 refers to photographing position data 520 included in battle area setting data 512 corresponding to the battle area 22 (current play area) stored in the storage section 500 as game space setting data 510, and moves the player's character 2 to a given position in the battle area 22. The PC operation control section 214 detects that the player has performed a shooting operation using the gun-type controller 1130, and controls the operation of the player's character 2 so that the player's character 2 fires the gun 3 at the sight position calculated by the sight position determination section 212.

The NPC operation control section 216 refers to script data 524 stored in the storage section 500, and controls the operation (e.g., appearance, movement, attack, and escape) of the enemy group 24 (i.e., enemy NPC 4). The NPC operation control section 216 also has an Al control function that automatically determines the operation of the enemy group 24 (i.e., enemy NPC 4) according to a given thinking routine.

The virtual camera automatic control section 218 automatically controls the photographing direction and the angle of view of the virtual camera CM (i.e., the first person point of view of the player's character 2). Specifically, the virtual camera automatic control section 218 selects the object group from the enemy groups that appear in the battle area 22 (current play area), selects the photographing target from the enemy NPCs that belong to the object group, and calculates the reference point G and the target angle of view θ so that the photographing target characters can be photographed. The virtual camera automatic control section 218 then pans and zoom-controls the virtual camera CM so that the photographing direction L aims at the reference point G and the angle of view coincides with the target angle of view θ. The virtual camera automatic control section 218 also calculates data and controls the virtual camera CM according to the first to third additional control processes.

The sound generation section 250 is implemented by a processor (e.g., digital signal processor (DSP) or sound synthesis IC) and an audio codec that can reproduce a sound file, for example. The sound generation section 250 generates a sound signal of a game-related effect sound, background music (BGM), or an operation sound based on the processing results of the game calculation section 210, and outputs the generated sound signal to the sound output section 350.

The sound output section 350 is implemented by a device that outputs sound such as effect sound or BGM based on the sound signal input from the sound generation section 250. In FIG. 1, the speaker 1124 corresponds to the sound output section 350.

The image generation section 260 is implemented by a processor (e.g., graphics processing unit (GPU) or a digital signal processor (DSP)), a video signal IC, a program (e.g., video codec), a drawing frame IC memory (e.g., frame buffer), and the like. The image generation section 260 generates one game image every frame time ( 1/60th of a second) based on the processing results of the game calculation section 210, and outputs an image signal of the generated game image to the image display section 360.

The image display section 360 displays a game image based on the image signal input from the image generation section 260. For example, the image display section 360 is implemented by an image display device such as a flat panel display, a cathode-ray tube (CRT), or a projector. In FIG. 1, the image display device 1122 corresponds to the image display section 360.

The communication control section 270 executes a data communication process, and exchanges data with an external device via the communication section 370.

The communication section 370 connects to the communication channel 1 to implement communication. The communication section 370 is implemented by a transceiver, a modem, a terminal adapter (TA), a jack for a communication cable, a control circuit, and the like. In FIG. 1, the communication device 1154 corresponds to the communication section 370.

The storage section 500 stores a system program that implements a function of causing the processing section 200 to control the gun shooting game device 1100, a game program and data necessary for causing the processing section 200 to execute the game, and the like. The storage section 500 is used as a work area for the processing section 200, and temporarily stores the results of calculations performed by the processing section 200 based on a program, data input from the operation section 100, and the like. The function of the storage section 500 is implemented by an IC memory (e.g., RAM or ROM), a magnetic disk (e.g., hard disk), an optical disk (e.g., CD-ROM or DVD), or the like. In FIG. 1, the flash memory 1152 included in the control unit 1150 or the like corresponds to the storage section 500.

In this embodiment, the storage section 500 stores a system program 502 and a game program 504. The function of the game calculation section 210 can be implemented by causing the processing section 200 to read and execute the game program 504.

The game program 504 includes an NPC control program 506 that causes the processing section 200 to function as the NPC operation control section 216.

The storage section 500 stores game space setting data 510, character initial setting data 522, script data 524, angle-of-view setting data 526, and attack priority setting data 528 as data provided in advance.

The storage section 500 also stores character status data 530, main object setting data 532, special camera work control data 534, and virtual camera control data 536 as data that is appropriately generated and rewritten during the game process.

The storage section 500 also appropriately stores data (e.g., position coordinate and posture information about the virtual camera CM in the virtual three-dimensional space coordinate system, a counter value, and a timer value) that is required for the game process.

Data for forming the game space in the virtual thee-dimensional space is stored as the game space setting data 510 corresponding to each piece of battle area setting data 512.

The battle area setting data 512 includes area vertex data 514 (i.e., battle area vertex position coordinates), obstacle placement data 516 that defines the position and posture of an object that that may serve as an obstacle, obstacle model data 518 (i.e., model data and texture data of an object that may serve as an obstacle), and photographing position data 520 that defines the position of the player's character 2 (i.e., the position of the virtual camera CM) in the battle area.

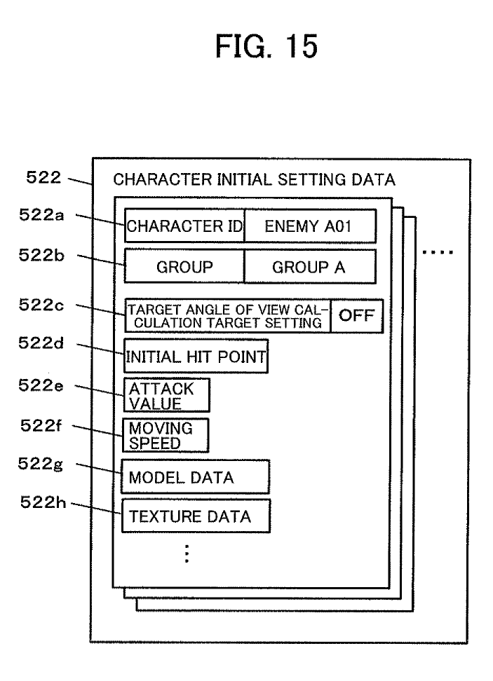

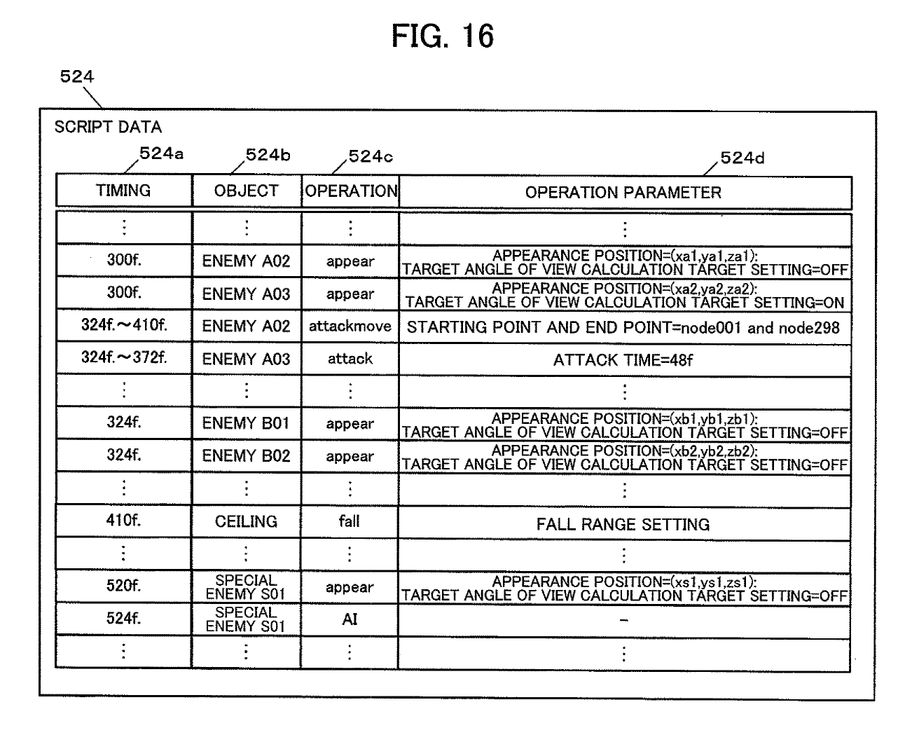

Initial setting data relating to the player character 6 and the enemy character 8 is stored as the character initial setting data 522. As shown in FIG. 15, a character ID 522a, a group 522b that stores identification information about the group to which the character belongs, a target angle of view calculation target setting 522c, an initial hit point 522d, an attack value 522e, a moving speed 522f, model data 522g, and texture data 522h are stored as the character initial setting data 522 corresponding to each character, for example. Motion data during a combat operation (e.g., shooting operation or lie-down operation) and the like are also appropriately stored as the character initial setting data 522.

The script data 524 is data that sets an event (e.g., the timing and the details of the operation of the enemy NPC 4, and the timing and the details of an event (e.g., a collapse of the ceiling or a change in game stage) during the game process.

As shown in FIG. 16, a target object 524b, an operation 524c, and an operation parameter 524d that defines the details of the operation are stored as the script data 524 corresponding to each timing 524a, for example. A frame number that corresponds to the elapsed time from the start of the game is stored as the timing 524a. Identification information about the enemy NPC 4 or identification information about the moving obstacle object (e.g., ceiling that collapses or an automobile that explodes) or the background object is stored as the object 524b. A subroutine or a function of an operation control program is defined as the operation 524c. A parameter necessary for operation control is stored as the operation parameter 524d.

For example, when the timing 524a is “300f (frame)”, the enemy NPC 4 having the ID “Enemy A02” and the enemy NPC 4 having the ID “Enemy A03” appear at the coordinates “appearance position=(x1,y1,z1)” and the coordinates “appearance position=(x2,y2,z2)” in the game space. The target angle of view calculation target setting of the enemy NPC 4 having the ID “Enemy A02” is OFF, and the target angle of view calculation target setting of the enemy NPC 4 having the ID “Enemy A03” is ON. The enemy NPC 4 having the ID “Enemy A02” moves in the game space between the starting point “node001” and the end point “node298” in the frames 324f to 410f. The enemy NPC 4 having the ID “Enemy A03” performs an attack operation in the frames 324f to 372f.

An event in which a ceiling (ceiling falling object) falls within a given fall range is set corresponding to the frame 410f. For example, a ceiling (part) falls as a falling object due to explosion or the like, and the player's character 2 or the enemy NPC 4 hit by the falling object is damaged. In this embodiment, the player's character 2 or the enemy NPC 4 is damaged by decrementing the hit point. Note that the player's character 2 or the enemy NPC 4 may be damaged by setting an abnormal status that results in a decrease in combat capability (e.g., paralysis or faint) for a given period of time.

The angles of view θn, θm, and θf are set as the angle-of-view setting data 526 corresponding to the relative distance between the NPC (object) and the virtual camera CM in a control mode in which a given enemy NPC is photographed as the object (see FIG. 9).

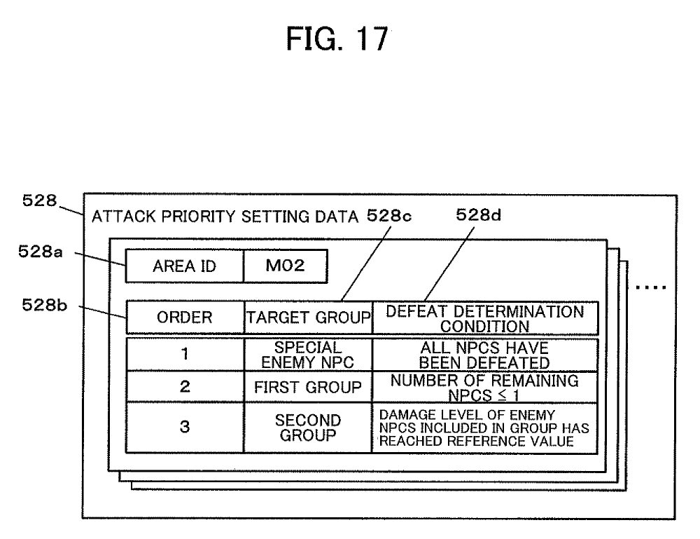

As shown in FIG. 17, an area ID 528a (battle area identification information), an order 528b, a target group 528c, and a defeat determination condition 528d are stored as the attack priority setting data 528 corresponding to each battle area. Identification information about an NPC or a group for which the priority is set, is stored as the target group 528c. A condition whereby it is determined that the threat of the target group 528c has been removed so that the target group 528c is canceled from the object (defeat condition) is defined as the defeat determination condition 528d. The defeat determination condition 528d may be a condition whereby the enemy NPCs that belong to the corresponding group have been defeated, a condition whereby some of the enemy NPCs that belong to the corresponding group remain undefeated, or a condition whereby the total damage value of the enemy NPCs that belong to the corresponding group satisfies a given condition (e.g., the upper limit determined corresponding to the game level), for example. This implements realistic camera work that imitates the line of sight of a soldier in a battlefield (e.g., attacks the next enemy when the threat of the current enemy group has been removed to a certain extent).

In this embodiment, the total value of the hit points of the enemy NPCs that belong to the group is used as the damage level of each group. When employing a configuration in which the enemy NPC is damaged by setting an abnormal status that results in a decrease in combat capability (e.g., paralysis or faint) for a given period of time, the number of enemy NPCs for which an abnormal status is set may be set as the defeat determination condition 528d.

The character status data 530 is provided corresponding to each character that appears in the game. Data that indicates the current status of the corresponding character is stored as the character status data 530 (see FIG. 14).

A character ID 530a, a group 530b (i.e., identification information about the group to which the character belongs), a hit point 530c, a current position 530d (i.e., position coordinates in the game space), and an operation control parameter 530e (e.g., the type of the current operation and motion control information about the current operation) are stored as the character status data 530, for example. Note that other pieces of information may also be appropriately stored as the character status data 530.

Identification information about the group or the NPC that is currently set as the object is stored as the main object setting data 532.

Information necessary for a special camera work that is implemented by the second additional control process (see FIGS. 10 to 12) is stored as the special camera work control data 534. For example, a special reference point 534a, a special target angle of view 534b, and a special camera work execution flag 534c (that is set to “1” when a special camera work is performed) are stored as the special camera work control data 534. Note that other pieces of information may also be appropriately stored as the special camera work control data 534. The initial value of the special camera work execution flag 534c when the game starts is “0”.

The current position coordinates, photographing direction L, and angle of view of the virtual camera CM are stored as the virtual camera control data 536.

Operation

The operation of the gun shooting game device 1100 according to this embodiment is described below. The following process is implemented by causing the processing section 200 to read and execute the system program 502 and the game program 504.

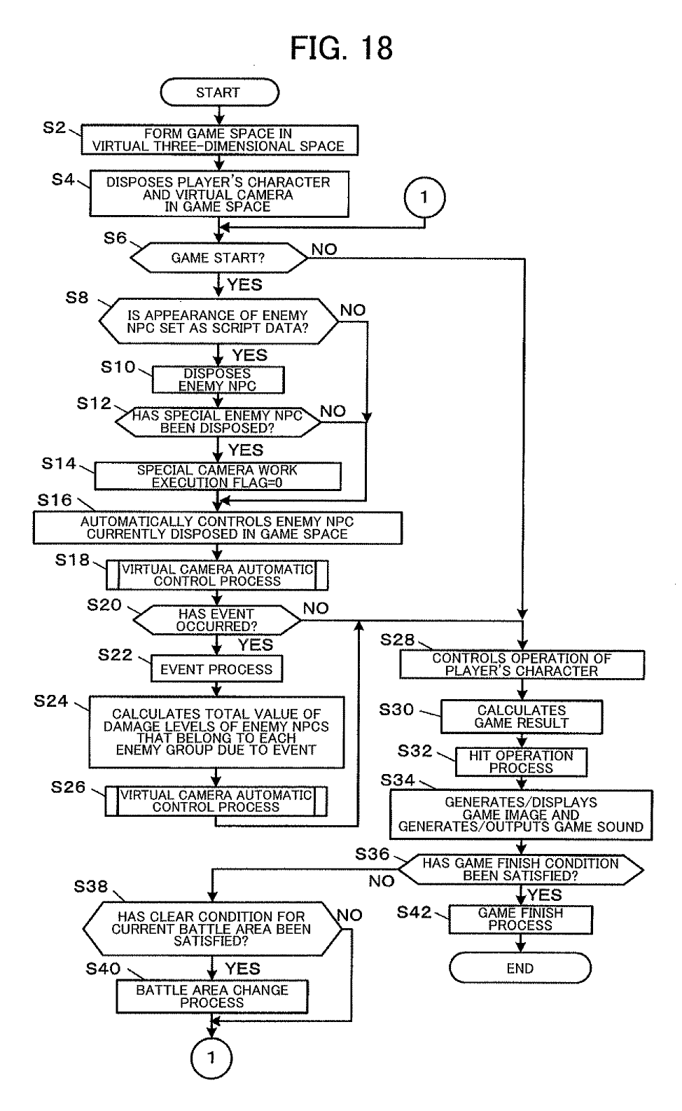

FIG. 18 is a flowchart illustrative of the flow of the main processes according to this embodiment. As shown in FIG. 18, the game calculation section 210 refers to the game space setting data 510 and the character initial setting data 522, disposes the obstacle object (e.g., the building 8 and the wooden box 10) (see FIG. 2) and the background object in the virtual three-dimensional space to form a game space (step S2), and disposes the player's character 2, the enemy NPC 4, and the virtual camera CM in the game space (step S4).

The processing section 200 then determines whether or not the game has started (step S6).

When the game has started (YES in step S6), the processing section 200 counts the number of drawing frames (i.e., a parameter that indicates the elapsed time from the start of the game) in the same manner as known video game control. The processing section 200 repeatedly executes steps S8 to S38 in a control cycle that is equal to or sufficiently shorter than the refresh rate of the image display device 1122 until the game finish condition is satisfied.

Specifically, the processing section 200 refers to the script data 524. When the current time is set as the appearance timing of the enemy NPC (YES in step S8), the processing section 200 causes the enemy NPC to appear at the designated position coordinates (step S10). When the enemy NPC that has appeared is the special enemy NPC (YES in step S12), the processing section 200 sets the special camera work execution flag 534c to “0” (step S14).

The processing section 200 then automatically controls all of the enemy NPCs that are currently disposed in the game space (step S16). Note that the enemy NPC 4 that has been defeated by the player's character 2 is excluded from the control target. The processing section 200 automatically controls the movement and the attack operation of some of the enemy NPCs based on the script data 524. The processing section 200 AI-controls some of the enemy NPCs so that the enemy NPCs autonomously perform the combat operation including movement, attack, and escape.

The processing section 200 then executes a virtual camera automatic control process (step S18).

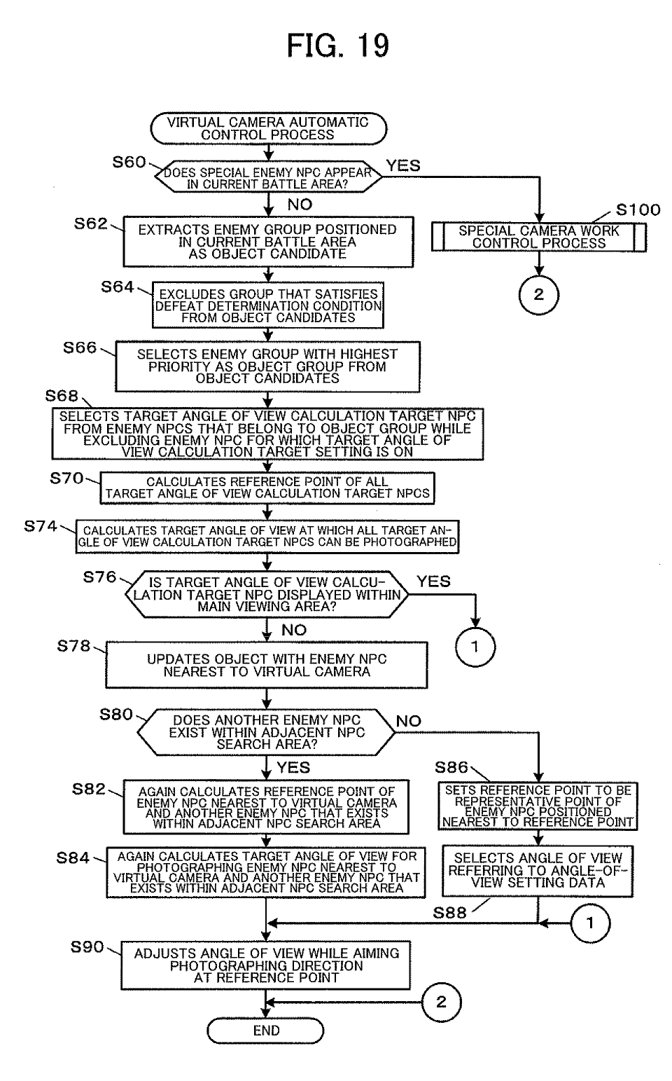

FIG. 19 is a flowchart illustrative of the flow of the virtual camera automatic control process according to this embodiment. The processing section 200 determines whether or not the special enemy NPC appears in the current battle area 22 (step S60).

When the special enemy NPC does not appear in the current battle area 22 (NO in step S60), the processing section 200 refers to the group 530b stored as the character status data 530 corresponding to the enemy NPC 4 that is positioned in the current battle area 22, extracts the enemy group that is positioned in the current battle area 22 as the object candidate (step S62), refers to the attack priority setting data 528 corresponding to the current battle area 22, and excludes the group that satisfies the defeat determination condition 528c from the object candidates (step S64).

The processing section 200 refers to the attack priority setting data 528 corresponding to the current battle area 22, and selects the enemy group with the highest priority as the object group from the object candidates based on the order 528a corresponding to each enemy group extracted as the object candidate (step S66). The identification information about the selected enemy group is stored as the main object setting data 532 (i.e., the main object has been set).

For example, when the defeat determination condition 528d (see FIG. 17) “the damage level of the enemy NPCs included in the group has reached a reference value” is set for the corresponding group, the total value of the damage levels (e.g., the difference between the initial hit point and the current hit point) of the enemy NPCs included in the group is calculated in the step S64. When the total value has reached the reference value, the group is excluded from the object candidates. In this case, the processing section 200 selects another group as the object in the step S66. Specifically, when a group for which the total damage level has reached the reference value is selected as the object until the total damage level reaches the reference value, the processing section 200 determines that the threat has been removed by the attack operation of the player's character 2 or the like, and automatically selects another enemy group as the object.

The processing section 200 then selects the target angle of view calculation target NPC from the enemy NPCs that belong to the selected object group while excluding the enemy NPC for which the target angle of view calculation target setting 522c (see FIGS. 15 and 16) is “ON” (step S68). The processing section 200 calculates the reference point G (i.e., photographing reference point) based on the position coordinates of all of the target angle of view calculation target NPCs (step S70).

The processing section 200 calculates the target angle of view θ at which all of the target angle of view calculation target NPCs can be photographed (step S74). The processing section 200 then calculates the target angle of view so that the characters are displayed as large as possible within the safe area or the main viewing area 32 when the photographing direction L of the virtual camera CM aims at the reference point G such that the target angle of view calculation target NPC positioned on the end overlaps the outer edge of the safe area or the main viewing area 32.

The processing section 200 determines whether or not the target angle of view calculation target NPC is displayed within the main viewing area 32 (see FIG. 8) (step S76).

When the processing section 200 has determined that the target angle of view calculation target NPC is not displayed within the main viewing area 32 (NO in step S76), the processing section 200 selects the enemy NPC positioned nearest to the virtual camera CM as a new object from the target angle of view calculation target NPCs (enemy NPCs) that belong to the current object group, and stores the identification information about the selected enemy NPC as the main object setting data 532 to update the object (step S78). Specifically, the control mode is temporarily changed from a control mode that photographs the entire group as the object to a control mode that photographs a single NPC as the object.

The processing section 200 determines whether or not another enemy NPC that belong to the same group as the enemy NPC that is positioned nearest to the virtual camera CM and has been selected as a new object is positioned within the adjacent NPC search area 36 (see FIG. 9B) set around the enemy NPC that is positioned nearest to the virtual camera CM (step S80).

When another enemy NPC that satisfies the above condition exists (YES in step S80), the processing section 200 again calculates the reference point G so that the enemy NPCs that satisfy the above condition are also displayed on the screen together with the enemy NPC that is positioned nearest to the virtual camera CM (step S82), and calculates the target angle of view so that the enemy NPCs are displayed as large as possible within the main viewing area 32 when the photographing direction L of the virtual camera CM aims at the calculated reference point G (step S84).

When another enemy NPC is not positioned within the adjacent NPC search area 36 (NO in step S80), the processing section 200 sets the reference point G to be the position coordinates of the representative point of the enemy NPC that is positioned nearest to the position coordinates of the reference point G (step S86), calculates the distance between the enemy NPC that is positioned nearest to the position coordinates of the reference point G and the virtual camera CM, and selects the angle of view θn, θm, or θf as the target angle of view corresponding to the calculated distance referring to the angle-of-view setting data 526 (step S88).

The processing section 200 controls the virtual camera CM so that the photographing direction L aims at the reference point G and the angle of view coincides with the target angle of view θ (step S90), and finishes the virtual camera automatic control process in the current control cycle.

As a modification, a temporary reference point may be calculated in the step S70, and a temporary target angle of view may be calculated in the step S74. A step of comparing the temporary reference point and the temporary target angle of view with the current reference point G and the current target angle of view θ, and a step of updating the reference point and the target angle of view with the temporary reference point and the temporary target angle of view when a change in position or a change in angle of view that exceeds a reference value occurs, may be added between the steps S74 and S76.

In this case, a game screen for which a change in screen composition is suppressed can be provided by suppressing a change in the photographing direction L and the angle of view of the virtual camera CM. The update step and the configuration shown in the drawings may be appropriately employed corresponding to the game and the effects.

When the processing section 200 has determined that the special enemy NPC appears in the current battle area in the step S60 (YES in step S60), the processing section 200 executes a special camera work control process (step S100), and finishes the virtual camera automatic control process in the current control cycle.

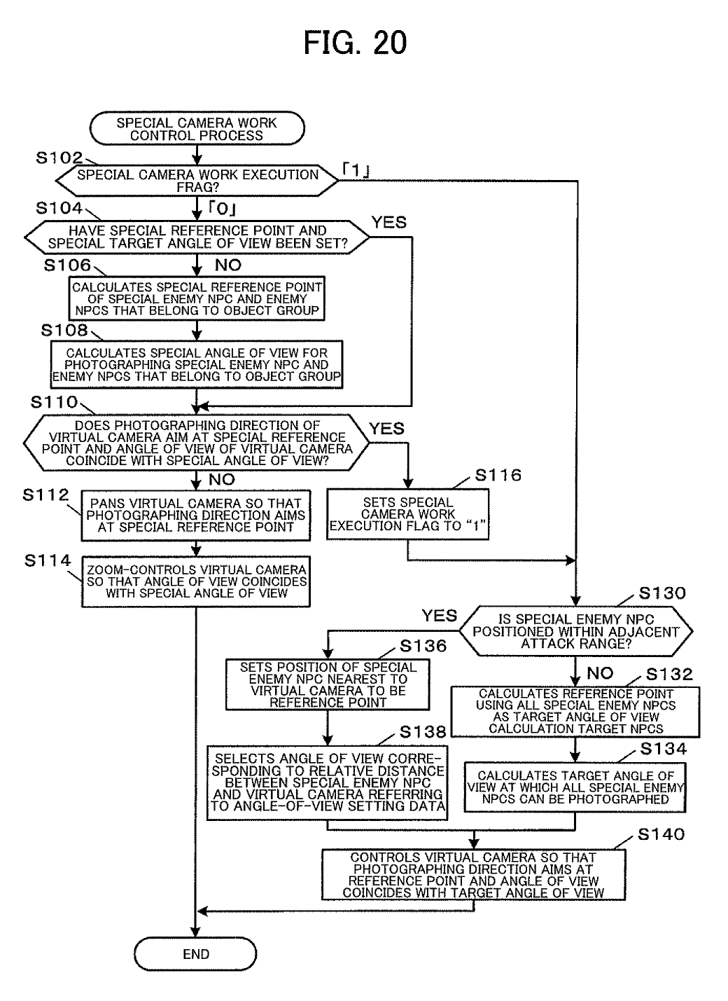

FIG. 20 is a flowchart illustrative of the flow of the special camera work control process according to this embodiment. The processing section 200 refers to the special camera work execution flag 534c stored as the special camera work control data 534 (step S102). When the special camera work execution flag 534c is “0” (“0” in step S102), the processing section 200 determines that a special camera work has not been executed, and determines whether or not the special reference point 534a and the special target angle of view 534b are set as the special camera work control data 534 (step S104).

When the special reference point 534a and the special target angle of view 534b are not set as the special camera work control data 534 (NO in step S104), the processing section 200 calculates the special reference point Gs (see FIG. 11) of the special enemy NPC 31 and all of the enemy NPCs 4 that belong to the group (object group) that is currently set as the object (step S106), and calculates the special angle of view θs (step S108).

The processing section 200 then determines whether or not the current photographing direction L of the virtual camera CM aims at the special reference point Gs and the current angle of view of the virtual camera CM coincides with the special angle of view θs (step S110). When the processing section 200 has determined that the current photographing direction L of the virtual camera CM does not aim at the special reference point Gs and the current angle of view of the virtual camera CM does not coincide with the special angle of view θs (NO in step S110), the processing section 200 pans the virtual camera CM corresponding to the current control cycle so that the photographing direction L aims at the special reference point Gs (step S112), zoom-controls the virtual camera CM corresponding to the current control cycle so that the angle of view coincides with the special angle of view θs (step S114), and finishes the special camera work control process in the current control cycle.

When the processing section 200 has determined that the photographing direction L of the virtual camera CM aims at the special reference point Gs and the angle of view of the virtual camera CM coincides with the special angle of view θs after several control cycles (YES in step S110), the processing section 200 sets the special camera work execution flag 534c to “1” (step S116).

When the special camera work execution flag 534c is “1”, the processing section 200 determines whether or not the special enemy NPC 31a is positioned within the adjacent attack range 38 (see FIG. 13) (step S130). When the processing section 200 has determined that the special enemy NPC 31a is not positioned within the adjacent attack range 38 (NO in step S130), the processing section 200 calculates the reference point G using all of the special enemy NPCs that appear in the current battle area 22 as the target angle of view calculation target NPCs (step S132), and calculates the target angle of view θ at which all of the special enemy NPCs can be photographed when the photographing direction L of the virtual camera CM aims at the reference point G (step S134). The processing section 200 then controls the virtual camera CM so that the photographing direction L aims at the reference point Gs and the angle of view coincides with the target angle of view θ (step S140), and finishes the special camera work control process in the current control cycle.

When the processing section 200 has determined that the special enemy NPC 31a is positioned within the adjacent attack range 38 in the step S130 (YES in step S130), the processing section 200 sets the position of the special enemy NPC nearest to the virtual camera CM to be the reference point G (step S136), and selects the angle of view θn, θm, or θf as the target angle of view corresponding to the relative distance between the special enemy NPC and the virtual camera CM referring to the angle-of-view setting data 526 (step 8138). The processing section 200 then controls the virtual camera CM so that the photographing direction L aims at the reference point Gs and the angle of view coincides with the target angle of view θ (step S140), and finishes the special camera work control process in the current control cycle.

When the processing section 200 has finished the special camera work control process, the processing section 200 finishes the virtual camera automatic control process in the current control cycle (see FIG. 19).

Again referring FIG. 18, the processing section 200 refers to the script data 524, and executes an event generation process (step S22) when an event is set corresponding to the current timing (YES in step S20). The processing section 200 calculates the total value of the damage levels of the enemy NPCs 4 that belong to each enemy group due to the event (step S24), and again executes the virtual camera automatic control process (step S26).

In this embodiment, an event (e.g., a ceiling (part) falls as a falling object or a car explodes) that randomly damages the player's character 2 or the enemy NPC 4 so that the situation changes is defined. Therefore, the enemy NPC 4 may be damaged due to the event and become unable to fight against the player's character 2. Specifically, the current object group may satisfy the defeat determination condition 528d (see FIG. 17) due to the event. Therefore, the processing section 200 again executes the virtual camera automatic control process in the step S26, and selects the object. Note that the processing section 200 does not again execute the virtual camera automatic control process when no event occurs.

The processing section 200 then controls the operation of the player's character (step S28). Specifically, the processing section 200 calculates the sight position coordinates in the game screen coordinate system indicated by the muzzle of the gun-type controller 1130, displays the sight 6 at the sight position coordinates, and controls the operation of the player's character so that the player's character aims the gun at a position in the game space that corresponds to the sight position. The processing section 200 detects the shooting operation performed using the gun-type controller 1130, and controls the operation of the player's character so that the player's character shoots the gun at a position in the game space that corresponds to the current sight position coordinates. The above process may be implemented in the same manner as in a known gun shooting game.

The processing section 200 then calculates the game result (step S30). Specifically, the processing section 200 performs an attack hit determination process on the player's character and the enemy NPC, a damage hit determination process on the enemy NPC due to an event (e.g., falling object or explosion), decrements the hit point of the player's character or the enemy NPC based on the attack hit determination result and the damage hit determination result, and updates the hit point gauge 12, the bullet gauge 14, and the direction indicator 16, for example. The processing section 200 executes a hit operation process (e.g., displays a spark at the hit position or causes the enemy NPC that has been hit to fall) corresponding to the current control cycle based on the calculated game result (step S32).

The processing section 200 then renders an image (game space image) of the game space photographed using the virtual camera CM, and synthesizes the game space image with various information indicators such as the hit point gauge 12 to generate a game screen. The processing section 200 displays the generated game screen on the image display section 260 (i.e., image display device 1122). The processing section 200 generates a game sound, and outputs the generated game sound from the sound output section 350 (i.e., speaker 1124) (step S34).

The processing section 200 then determines whether or not the game finish condition has been satisfied (step S36). In this embodiment, the processing section 200 determines that the game finish condition has been satisfied when the hit point of the player's character has reached “0” (i.e., game over) or the player's character has reached a given goal point before the hit point of the player's character reaches “0” (game clear).

When the processing section 200 has determined that the game finish condition has not been satisfied (NO in step S36), the processing section 200 determines whether or not a clear condition for the current battle area 22 has been satisfied (step S38).

When the processing section 200 has determined that the clear condition has been satisfied (e.g., when all of the groups have been defeated or all of the special enemy NPCs have been defeated) (YES in step S38), the processing section 200 changes the battle area 22 (step S40). The step S40 corresponds to a game stage change process. When the battle area 22 has been changed, the photographing position of the virtual camera CM is determined based on the photographing position data 520 corresponding to the current battle area 22. The processing section 200 then returns to the step S6.

When the processing section 200 has determined that the game finish condition has been satisfied (YES in step S36), the processing section 200 performs a game finish process (e.g., displays a given game finish notification screen corresponding to the game result (game over or game clear) (step S42), and finishes the process.

According to this embodiment that implements a first-person game in which the battle operation of the player's character is controlled in the battle area in which a plurality of enemy groups formed by one or more enemy NPCs appear, a specific enemy group can be selected as the object, and the virtual camera CM can be controlled so that all of the enemy NPCs that belong to the selected group are displayed on the game screen. The virtual camera CM automatically selects another group with a second-order attack priority as the object when the selected group has been defeated, and is automatically controlled so that all of the enemy NPCs that belong to the selected group are displayed on the game screen. Moreover, when a new enemy NPC with a priority higher than that of the current object group has appeared, the virtual camera CM is automatically controlled so that the new enemy NPC is first photographed together with the enemy NPC group selected as the current object group and is then mainly displayed on the game screen.

Therefore, the target group with the highest attack priority is preferentially displayed on the game screen so that the target group can be easily identified. Therefore, the player can enjoy a refreshing game by shooting the targets one after another.

Modification

The embodiments to which the invention is applied have been described above. Note that the invention is not limited thereto. Various modifications may be appropriately made, such as adding other elements, omitting some of the elements, or changing some of the elements.

The above embodiments have been described taking an example of executing the gun shooting game. Note that the invention may also be applied to other games (e.g., RPG or strategy simulation game) insofar as an NPC appears in the game.

The hardware is not limited to the gun shooting game device 1100 for business use, but may be a consumer game device, a portable game device, a personal computer, or the like.

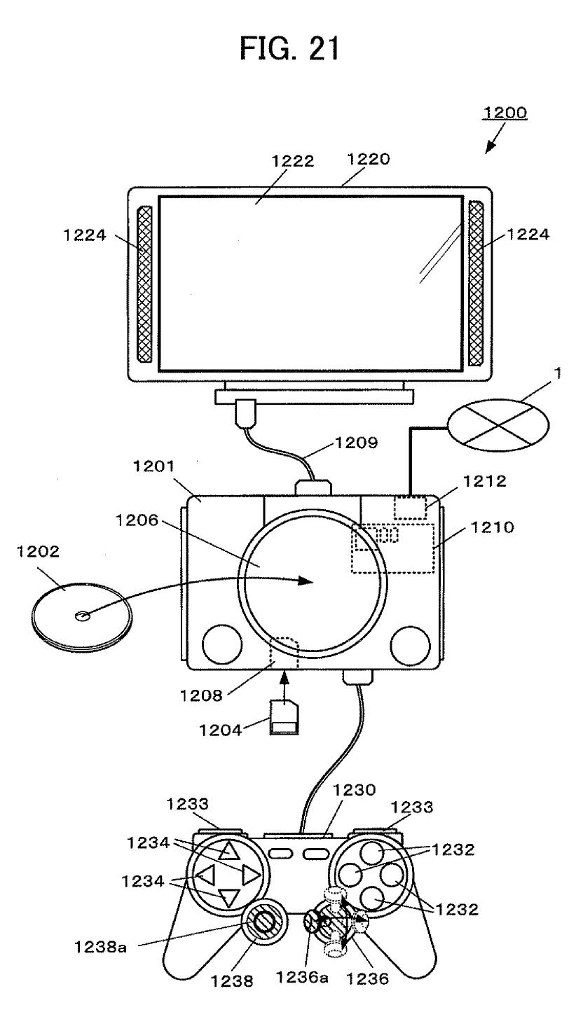

For example, a consumer game device 1200 shown in FIG. 21 is a computer system that includes a game device main body 1201, a game controller 1230, and a video monitor 1220. The game device main body 1201 includes a control unit 1210 provided with a CPU, an image processing LSI, an IC memory, and the like, and readers 1206 and 1208 for reading data from information storage media such as an optical disk 1202 and a memory card 1204. The control unit 1210 reads a game program and setting data from the optical disk 1202 and the memory card 1204, and executes various game calculations based on an operation input performed using the game controller 1230.

The control unit 1210 includes electrical/electronic instruments such as various processors (e.g., a central processing unit (CPU), a graphics processing unit (GPU), and a digital signal processor (DSP)), an application-specific integrated circuit (ASIC), and an IC memory, and controls each section of the consumer game device 1200. The control unit 1210 includes a communication device 1212 which connects to a communication line I (e.g., Internet, local area network (LAN), or wide area network (WAN)) and implements data communication with an external device.

The game controller 1230 includes push buttons 1232 used for selection, cancellation, timing input, and the like, arrow keys 1234 used to individually input an upward, downward, rightward, or leftward direction, a right analog lever 1236, and a left analog lever 1238. When executing the gun shooting game, the operation (e.g., trigger operation or weapon change operation) of the player's character may be input using the push button 1232, and the position of the sight 6 may be moved upward, downward, rightward, or leftward using the left analog lever 1238.

The control unit 1210 generates a game image and game sound based on a detection signal and an operation input signal received from the game controller 1230. The game image and the game sound generated by the control unit 1210 are output to the video monitor 1220 (display monitor) connected to the game device main body 1210 via a signal cable 1209. The video monitor 1220 includes a device 1222 that displays an image, and a speaker 1224 that outputs sound The player plays the game while watching a game image displayed on the image display device 1222 and listening to a game sound output from the speaker 1224.

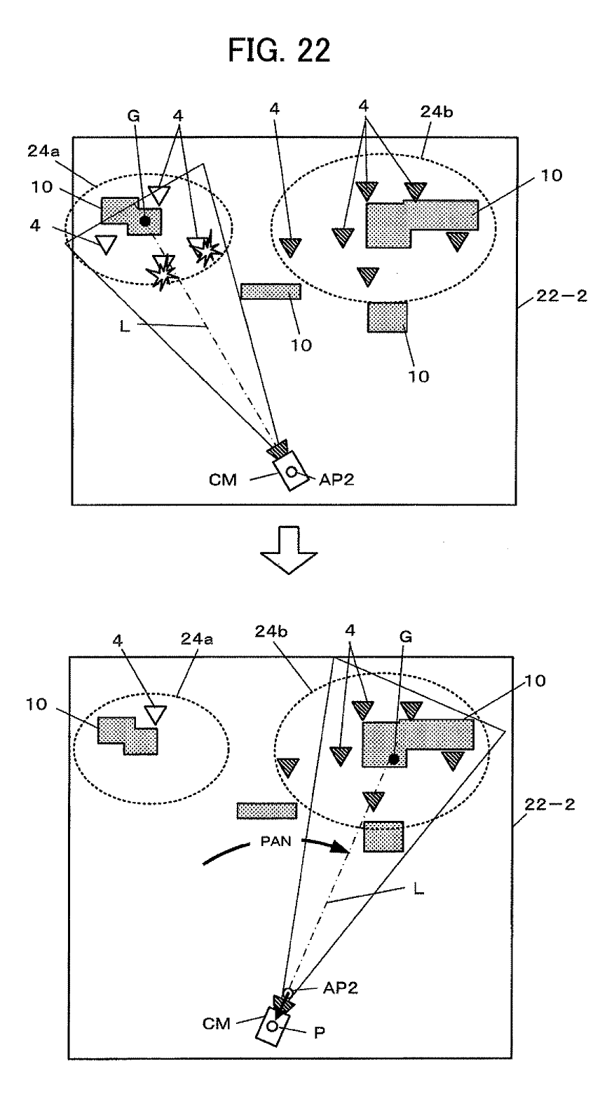

As shown in FIG. 22, the adjustment of the angle of view of the virtual camera CM according to the above embodiments may be replaced by the back and forth movement of the virtual camera CM (track control (camera control term)) with respect to the reference point G. The example shown in FIG. 22 corresponds to a change from the state shown in FIG. 6 to the state shown in FIG. 7. In this case, the angle of view of the virtual camera CM is fixed or changed stepwise, step of calculating the target angle of view is replaced by a step of calculating a moving target position P, and the step of adjusting the angle of view to the target angle of view is replaced by a step of moving the virtual camera CM to the moving target position P.

The above embodiments have been described above taking an example in which the group with the highest attack priority is preferentially selected as the object. Note that the invention is not limited thereto.

For example, the player selects the game level before the game starts in the same manner as in a known video game. The group with the highest attack priority is preferentially selected as the object when the player has selected a low game level, and the object group is randomly selected irrespective of the attack priority or the group with the lowest attack priority is preferentially selected when the player has selected a high game level. Specifically, the game level is adjusted by selecting the object while displaying a group of the enemy NPCs as the main object. In this case, the NPC with the highest priority (e.g., the special enemy NPC 31 in the above embodiments) is preferably excluded from the selection target taking account of the game balance.

In the third additional control process according to the above embodiments, the special enemy NPC that has entered the adjacent attack range 38 is selected as a new object. Note that the normal enemy NPC may be included in the determination target. When the enemy NPC has entered the adjacent attack range 38, the group to which the enemy NPC belongs may be selected as a new object instead of selecting only the enemy NPC as a new object.

For example, a step of determining whether or not the enemy NPC is positioned within the adjacent attack range 38 may be added between the steps S60 and S62, and a step of setting the enemy group to which the enemy NPC that is positioned within the adjacent attack range 38 belongs as the object group may be executed in place of the steps S62 to S66. In this case, the enemy NPC that is positioned close to the player's character 2 can be preferentially displayed on the screen, and the group to which the enemy NPC belongs can also be displayed on the screen. Therefore, the player can deal with the enemy NPC that is positioned close to the player's character 2, and can determine the state of the group to which the enemy NPC belongs.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

1. A method that is implemented by a processor, the method comprising:
causing a plurality of enemy groups to appear in a battle area, each of the plurality of enemy groups being formed by one or more enemy non-playable characters (NPCs);
selecting an object enemy group from the plurality of enemy groups;
selecting an enemy NPC that is included within a viewing area from the one or more enemy NPCs that form the object enemy group;
calculating a photographing reference point based on a position of the enemy NPC that is included within the viewing area;
aiming a photographing direction of a virtual camera at the photographing reference point; and
generating an image using the virtual camera.

2. The method as defined in claim 1, further comprising:
controlling an angle of view of the virtual camera based on the position of the enemy NPC that is included within the viewing area.

3. The method as defined in claim 1,
photographing target information that indicates whether or not include a corresponding enemy NPC within the viewing area being defined in advance corresponding to each of the enemy NPCs; and
the selecting of the enemy NPC including selecting the enemy NPC based on the photographing target information.

4. The method as defined in claim 1, further comprising:
moving a player's character to a new battle area when a given clear condition that is defined in advance corresponding to each battle area has been satisfied; and
selecting a new object enemy group from other enemy groups that are positioned in the battle area when the object enemy group has been defeated and the given clear condition has not been satisfied.

5. The method as defined in claim 1,
the selecting of the new object enemy group including selecting the new object enemy group based on a priority that is set corresponding to each of the plurality of enemy groups.

6. The method as defined in claim 1, further comprising:
calculating a damage state of each of the plurality of enemy groups; and
selecting a new object enemy group when the damage state of the object enemy group has satisfied a given condition.

7. A method that is implemented by a processor, the method comprising:
causing a plurality of enemy groups to appear in a battle area, each of the plurality of enemy groups being formed by one or more enemy non-playable characters (NPCs);
selecting an object enemy group from the plurality of enemy groups;
controlling a virtual camera while setting the object enemy group as a photographing target;
generating an image using the virtual camera;
calculating a damage state of the object enemy group; and
selecting a new object enemy group when the damage state of the object enemy group has satisfied a given condition.

8. The method as defined in claim 1, further comprising:
selecting a new object enemy group when a given event has occurred during a game.

9. The method as defined in claim 1, further comprising:
selecting an enemy NPC among the one or more enemy NPCs that form the object enemy group as a focus NPC when the one or more enemy NPCs that form the object enemy group are not photographed within a given center range of the image using the virtual camera; and
correcting a photographing direction and an angle of view of the virtual camera so that the focus NPC is photographed within the given center range.

10. The method as defined in claim 7, further comprising:
selecting an enemy NPC among the one or more enemy NPCs that form the object enemy group as a focus NPC when the one or more enemy NPCs that form the object enemy group are not photographed within a given center range of the image using the virtual camera; and
correcting a photographing direction and an angle of view of the virtual camera so that the focus NPC is photographed within the given center range.

11. The method as defined in claim 9, further comprising:
controlling the virtual camera so that the focus NPC and another NPC that is positioned within a given range around the focus NPC are photographed within the given center range.

12. The method as defined in claim 1, further comprising:
correcting a photographing direction and an angle of view of the virtual camera so that a current object enemy group and a given priority enemy group are photographed when the priority enemy group has appeared in the battle area and is positioned within the viewing area.

13. The method as defined in claim 12, further comprising:
controlling the virtual camera while setting the priority enemy group as a new object enemy group after correcting the photographing direction and the angle of view of the virtual camera so that the current object enemy group and the priority enemy group are photographed.

14. The method as defined in claim 7, further comprising:
correcting a photographing direction and an angle of view of the virtual camera so that a current object enemy group and a given priority enemy group are photographed when the priority enemy group has appeared in the battle area and is positioned within the viewing area.

15. The method as defined in claim 14, further comprising:
controlling the virtual camera while setting the priority enemy group as a new object enemy group after correcting the photographing direction and the angle of view of the virtual camera so that the current object enemy group and the priority enemy group are photographed.

16. The method as defined in claim 1,
the virtual camera being set as a first-person viewpoint of a player's character; and
the method farther comprising controlling the virtual camera while setting an enemy NPC that has entered a given adjacent range or an enemy group to which the enemy NPC that has entered the adjacent range belongs as an object, the adjacent range being formed around the virtual camera or the player's character.

17. The method as defined in claim 7,
the virtual camera being set as a first-person viewpoint of a player's character; and
the method further comprising controlling the virtual camera while setting an enemy NPC that has entered a given adjacent range or an enemy group to which the enemy NPC that has entered the adjacent range belongs as an object, the adjacent range being formed around the virtual camera or the player's character.

18. A computer-readable storage medium storing a program that causes a computer device to execute the method as defined in claim 1.

19. A computer device comprising:
an enemy control section that causes a plurality of enemy groups to appear in a battle area and controls an enemy non-playable character (NPC), each of the plurality of enemy groups being formed by one or more enemy NPCs;
an object selection section that selects an object enemy group from the plurality of enemy groups;
a viewing area selection section that selects an enemy NPC that is included within a viewing area from the one or more enemy NPCs that form the object enemy group;
a reference point calculation section that calculates a photographing reference point based on a position of the enemy NPC that is included within the viewing area;
a virtual camera control section that aims a photographing direction of a virtual camera at the photographing reference point; and
an image generation section that generates an image using the virtual camera.

20. A computer device comprising:
an enemy control section that causes a plurality of enemy groups to appear in a battle area and controls an enemy non-playable character (NPC), each of the plurality of enemy groups being formed by one or more enemy NPCs;
an object selection section that selects an object enemy group from the plurality of enemy groups;
a virtual camera control section that controls a virtual camera while setting the object enemy group as a photographing target;
an image generation section that generates an image using the virtual camera; and
a state calculation section that calculates a damage state of the object enemy group,
the object selection section selecting a new object enemy group when the damage state of the object enemy group calculated by the state calculation section has satisfied a given condition.
